(19) United States
(12) Patent Application Publication
(10) Pub. No.: US 2008/0197974 A1
(43) Pub. Date: Aug. 21, 2008

(54) Radio Frequency Identification Data Processing System

(76) Inventor: Hee Seung Kim, Seoul (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/914,738

(22) PCT Filed: May 16, 2006
(86) PCT No.: PCT/KR2006/001826

§ 371 Date: Nov. 16, 2007

Related U.S. Application Data
(60) Provisional application No. 60/681,585, filed on May 16, 2005.

(51) Int. Cl. H04B 7/00; H04Q 5/22

(52) U.S. Cl. 340/10.1

(57) ABSTRACT

An RFID tag data processing system is provided. In the RFID tag data processing system, RFID tag data are used to obtain an address value of a content server from a connection data server. The address obtained from the connection data server is used to access the corresponding content server, thereby enabling a user to access necessary contents.

### TECHNICAL FIELD

The present invention relates to a method and device for recognizing and processing radio frequency identification (RFID) data.

### BACKGROUND ART

The ISO and EPC standards define a reader protocol that supports connection of an RFID reader to a host through a network. In RFID systems, an RFID reader is mounted on a mobile phone or attached to the mobile phone in a dongle configuration. An RFID reader control unit of the mobile phone controls the RFID reader to write/read data to/from a tag.

In mobile phone environments, an RFID system is employed between a processor (e.g., MPU and MCU) of a mobile phone and an RFID reader chip installed in the mobile phone. Alternatively, a reader protocol is employed between a mobile phone and an RFID reader attached onto the mobile phone in a dongle configuration. When an RFID reader is attached onto a mobile phone in a dongle configuration, the RFID reader and the mobile phone are connected by an interface unit such as UART or USB.

### DISCLOSURE OF INVENTION

### Technical Problem

An object of the present invention is to provide an RFID tag data processing method and an RFID data processing system.

Another object of the present invention is to provide an RFID data processing method and system, which processes, using RFID tag data, connection data of a server that actually provides contents.

A further another object of the present invention is to provide an RFID data processing method and system, which processes server connection data using RFID tag data in order to receive an address of a server that actually provides contents to a mobile terminal.

### Technical Solution

To achieve these objects and other advantages and in accordance with the purpose of the invention, as embodied and broadly described herein, there is provided an RFID data processing method including: recognizing tag data at a mobile terminal; obtaining connection data for access to contents from the recognized tag data; and accessing contents using the obtained connection data.

In another aspect of the present invention, there is provided an RFID data processing method including: recognizing tag data at a mobile terminal; connecting to a first server according to the recognized tag data to obtain connection data; and connecting to a second server using the obtained connection data to access corresponding contents.

In the RFID data processing method, the connection data may be position data for connection to a corresponding system.

In the RFID data processing method, the connection data may be URL-based server position data.

In the RFID data processing method, the connection data may be address data for receiving contents using an object ID or an EPC code in an RFID tag.

In the RFID data processing method, the first server may be an object directory server.

In the RFID data processing method, the first server may be an object directory server in which addresses of content servers corresponding to respective object ID are mapped. Alternatively, the first server may be an object directory server in which addresses of content servers corresponding to respective EPC codes are mapped.

In the RFID data processing method, the second server may be a content server.

In a further another aspect of the present invention, there is provided an RFID data processing system comprising: a connection data server for content server address data to a mobile terminal; and a mobile terminal for connecting to the connection data server according to tag data recognized using an RFID reader to obtain an content server address, and connecting to a corresponding content server using the obtained content server address.

It is to be understood that both the foregoing general description and the following detailed description of the present invention are exemplary and explanatory and are i ntended to provide further explanation of the invention as claimed.

### Advantageous Effects

In the RFID system according to the present invention, the data read from a tag by the RFID reader are used to obtain server connection data, and a corresponding server is connected on the basis of the obtained server connection data to directly access necessary data. Accordingly, it is possible to provide RFID system environments that make it possible to receive more abundant and various services and data from a related server on the basis of the tag.

### BRIEF DESCRIPTION OF THE DRAWINGS

FIGS. 1 and 2 illustrate the configurations of mobile RFID systems according to embodiments of the present invention.

FIGS. 3 and 4 illustrate examples of the structure of tag data according to embodiments of the present invention.

FIG. 5 illustrates the structure of a data processing system according to an embodiment of the present invention.

FIG. 6 is a flowchart illustrating a data processing method according to an embodiment of the present invention.

### BEST MODE FOR CARRYING OUT THE INVENTION

Reference will now be made in detail to the preferred embodiments of the present invention, examples of which are illustrated in the accompanying drawings.

An RFID data processing system according to the present invention includes: an RFID reader configured to read data written into a tag; and a tag data processor configured to recognize and process the data read by the RFID reader. The tag data processor may be, for example, a mobile terminal. The mobile terminal may be, for example, a mobile phone. The RFID reader may be installed in the mobile terminal. Alternatively, the RFID reader may be connected through an interface unit to the mobile terminal in a dongle configuration.

In the following embodiments of the present invention, a mobile terminal (e.g., a mobile phone) with an RFID reader is taken as an example of a terminal with an RFID reader control unit.

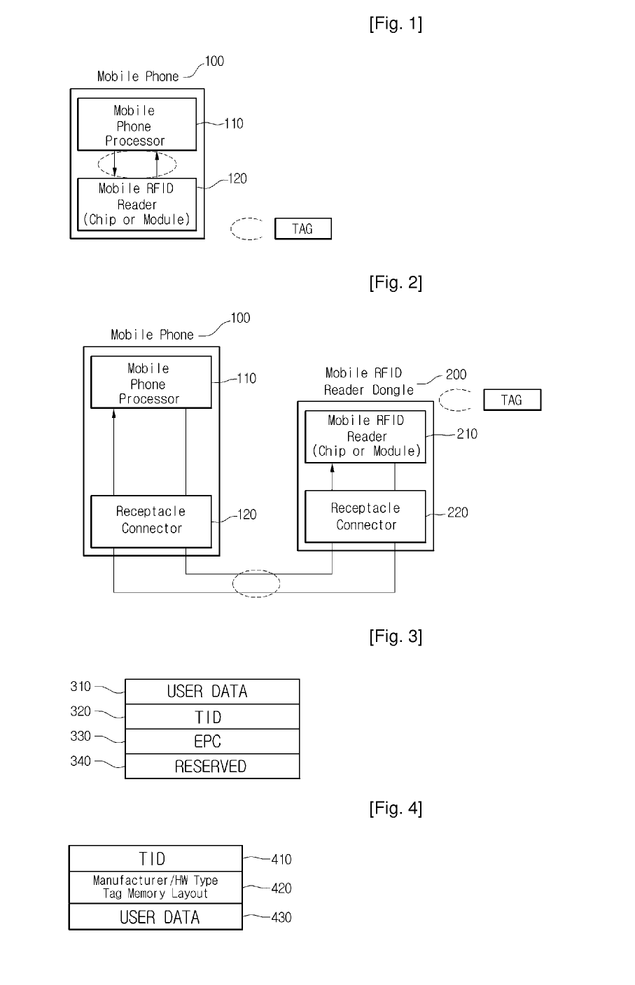

FIG. 1 illustrates a mobile RFID system configuration when a mobile RFID reader is installed in a mobile phone (which here is a mobile phone). FIG. 2 illustrates a mobile RFID system configuration when a mobile RFID reader is attached to the outside of a mobile phone (which here is a mobile phone) in a dongle configuration.

Referring to FIG. 1, a mobile phone 100 includes a mobile phone processor 110 and a chip-type or module-type mobile RFID reader 120. The mobile phone processor 110 controls the mobile RFID reader 120. Under the control of the mobile phone processor 110, the mobile RFID reader 120 writes/reads data to/from a tag. The tag data read by the mobile RFID reader 120 are transferred to the mobile phone processor 110. The mobile phone processor 110 decodes and recognizes the tag data. The mobile phone processor 110 stores the recognized tag data or provides the recognized tag data to a user using a display device.

Referring to FIG. 2, a mobile phone 100 includes a mobile phone processor 110 and a receptacle connector 120. A mobile RFID reader 210 is attached to the outside of the mobile phone 100 in a dongle configuration. The mobile RFID reader 210 is connected to the mobile phone 100 by receptacle connectors 120 and 220. The mobile phone processor 110 controls the mobile RFID reader 210 through the receptacle connectors 120 and 220. Under the control of the mobile phone processor 110, the mobile RFID reader 210 writes/reads data to/from a tag. The tag data read by the mobile RFID reader 210 are transferred to the mobile phone processor 110 through the receptacle connectors 120 and 220. The mobile phone processor 110 decodes and recognizes the tag data. The mobile phone processor 110 stores the recognized tag data or provides the recognized tag data to a user using a display device.

FIGS. 3 and 4 illustrate examples of the structure of tag data according to embodiments of the present invention. FIG. 3 illustrates an example of an EPG tag, and FIG. 4 illustrates an example of an ISO tag.

Referring to FIG. 3, a tag according to an embodiment of the present invention includes a user data area 310, a TID 320, an EPC 330, and a reserved area 340. The user data area 310 is assigned as an area to/from which users can freely store data. Tag data are written into the TID 320, and an EPC code is written into the EPC 330.

Referring to FIG. 4, a tag according to another embodiment of the present invention includes a TID 410, a data area 420, and a user data area 430. The data area 420 is used to store data about manufacturers, hardware types, and tag memory layouts. The user data area 430 is assigned as an area to/from which users can freely store data.

In this tag data structure, an address for receiving, at the mobile terminal, contents desired by the user is obtained using the object ID or the EPC code in the RFID tag.

That is, according to the present invention, the mobile terminal has an RFID reader. Connection to an object directory server (ODS) is performed to receive an address that is used to receive contents corresponding to a code value of a tag. The mobile terminal itself performs an ODS resolving process for receiving a desired address from the ODS. It can be understood that the ODS corresponds to an object name server (ONS) located on an EPC global RFID system. In this way, an ODS resolving module serving as the ONS provided in the EPC global RFID system is mounted on the mobile terminal, thereby making it possible to provide a mobile RFID related service.

Each object ID or EPC code and a content server address corresponding to each code are mapped in the ODS. The mobile terminal reads tag data and determines whether the data must pass through the ODS. When the data must pass through the ODS, communication with the ODS is performed to receive and obtain data of the content server. On the basis of the obtained connection data, the mobile terminal is connected to the corresponding content server. The connection to the server may be performed through a wired or wireless network.

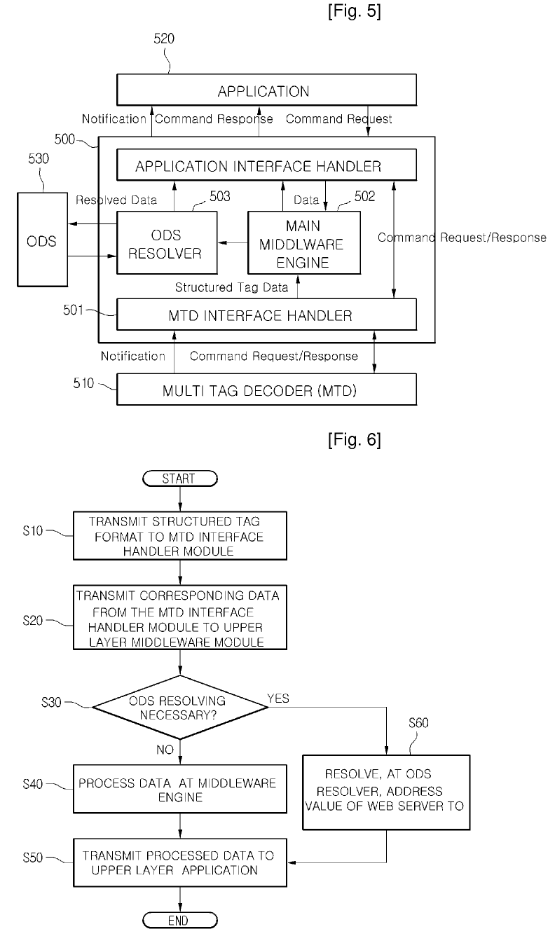

FIG. 5 illustrates the structure of an RFID data processing system according to an embodiment of the present invention. The RFID data processing system includes an ODS resolving middleware architecture in the mobile RFID reader.

Referring to FIG. 5, an RFID data processing system includes, a middleware unit 500, a tag decoder unit 510, an application unit 520, and an ODS 530. The middleware unit 500 includes a multi-tag decoder (MTD) interface handler 501, a main middleware engine 502, an ODS resolver 503, and an application interface handler 504.

The MTD 510 converts a variety of tag formats read from the tag into a general format and transfers the resulting data to the middleware unit 500. The data transferred from the MTD 510 to the middleware unit 500 includes Notification. Data exchanged between the middleware unit 500 and the MTD 510 includes a command request and a response.

The contents of a protocol performed between the RFID reader and the processor of the mobile terminal can be classified into three types, which are a command, a response, and a notification that is defined in the ISO and EPC standards. The command and the response exist and operate in pair. Only after a response corresponding to a command is received, the next command is executed. Each command and response has a peculiar code. Commands and responses in a mobile RFID reader protocol are categorized into reader control/management, tag read, tag write, tag lock/unlock, tag kill, and additional functions.

A notification is a protocol message that is transmitted from the RFID reader to the processor of the terminal. Unlike a response message, the notification protocol message is independent of a command. The notification can be for critical errors generated in the RFID reader. When a critical error is generated in the reader, the notification is used to inform the processor of the error. The critical errors are not defined in the present invention, but may be those defined by a vendor.

The MTD interface handler 501 takes charge of an interface with the MTD 510. The MTD interface handler 501 receives structured tag data from the MTD 510, and transmits the tag data to the main middleware engine 502. Also, the MTD interface handler 501 transfers a command, which is received through the application interface handler 504, to the MTD 510. Also, the MTD 510 transfers a response from the decoder 510 to the upper layer application unit 520.

The main middleware engine 502 receives and processes structured tag data that is received from the MTD 510 through the MTD interface handler 501. At this point, the main middleware engine 502 determines whether the structured tag data must pass through the ODS 530. When the structured tag data must pass through the ODS 530, the main middleware engine 502 transfers corresponding data to the ODS resolver 503. On the other hand, when the structured tag data need not pass through the ODS 530, the main middleware engine 502 transfers the processed data to the upper layer application 520 through the application interface handler 504. The application 520 displays the corresponding data on the display unit of the mobile terminal.

In response to the connection data from the main middleware engine 502, the ODS resolver 503 connects to and communicates with the ODS 530 to receive the connection data of the content server. The resolved data are transferred through the application interface handler 504 to the upper layer application 520. At this point, each object ID or EPC code and a content server address corresponding to each code are mapped in the ODS 530. Therefore, the connection data that the ODS resolver 503 obtain from the ODS 530 becomes the content server address. Accordingly, upon reception of these connection data, the upper layer application 520 connects to the content server using the corresponding connection data, which enables the user to access necessary contents. For example, using the content server address, the upper layer application 530 can receive contents, which is desired by the user, from a mobile service provider server through a WAP (wireless application protocol) browser.

Using the communication unit, the mobile terminal connects to a server indicated by the connection data through a wired or wireless network. The connection to the server makes it possible to obtain necessary contents from the server.

An example of the above connection data is the position data of the server. Examples of the server position data are a URL and an IP address. In most cases, an OID (object ID) or a TID (tag ID) is read from the RFID tag, and the position of a server storing necessary data is identified by a connection data server to receive the necessary data.

FIG. 6 is a flowchart illustrating an RFID data processing method according to an embodiment of the present invention.

According to the RFID data processing method illustrated in FIG. 6, the RFID reader connects to the ODS to receive an address that is used to receive contents, and receives a desired address from the ODS to connect to the corresponding content server.

The MTD 510 converts a variety of tag formats into a general format and transfers the resulting data to the middleware unit 500. The middleware engine 502 of the middleware unit 500 receives the resulting data and performs a necessary operation on the received data. The middleware unit 500 determines whether corresponding data must pass through the ODS 530. When the corresponding data must pass through the ODS 530, the middleware unit 500 transfers the corresponding data to the ODS resolver 503. On the other hand, when the corresponding data need not pass through the ODS 530, the middleware unit 500 transfers the data processed by the middleware engine to the upper layer application 520. The upper layer application 520 displays data on the display unit of the mobile terminal using the corresponding data. Data resolved the ODS resolver 503 are transferred to the upper layer application 520. Using the corresponding data, the upper layer application 520 receives contents, which is desired by the user, from a mobile service provider server through a WAP browser.

These operations will now be described in detail with reference to FIG. 6.

Referring to FIG. 6, in operation S 10, the RFID reader reads data of a tag, and the MTD (multi-tag decoder) transmits structured tag data to the MTD interface handler module.

In operation S20, the MTD interface handler module transmits the structure tag data to an upper layer middleware module.

In operation S30, it is determined whether an ODS resolving operation is necessary. When the ODS resolving process is not necessary, the RFID data processing method proceeds to operation S40. On the other hand, when the ODS resolving process is necessary, the method proceeds to operation S60.

In operation S40, when the ODS resolving process is not necessary, the middleware engine processes necessary data.

In operation S50, the data processed in operation S40 or S60 are transmitted to the upper layer application. When the corresponding data read and decoded need not pass through the ODS, the data processed in operation S40 are transmitted to the upper layer application and the upper layer application displays the corresponding data on the display unit of the mobile terminal. On the other hand, when the corresponding data need pass through the ODS, the data processed in operation S60 are transmitted to the upper layer application.

In operation S60, the ODS resolver resolves an address value of a Web server for receiving contents from the ODS. The resolved address value of the Web server is transmitted to the upper layer application through operation S50. In this case, using the content server connection data (i.e., the Web server address value), the upper layer application connects to a mobile service provider server through a WAP browser, thereby making it possible to access and receive contents desired by the user from the server.

On the basis of the connection data, the mobile terminal may connect to the corresponding contents server through a wired or wireless communication network. The data for the connection to the server may be the server position on the network. The position data may be, for example, a URL or an IP address of the server.

When the connection to the server is successful, data provided from the server are received at the mobile terminal. The received data are processed by the general data communication technology such as a decoding scheme, and the resulting data are stored in the mobile terminal or displayed on the display unit of the mobile terminal.

Accordingly, connection to the ODS is performed using a code value of the RFID tag. The content server address corresponding to the code is received at the mobile terminal. The mobile terminal connects to the corresponding server using the received content server address. Accordingly, it is possible to directly access necessary data or services from the server.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention is applied to an RFID system. It is possible to additionally obtain more abundant and various data through the related server using the data read from the tag. Also, it is possible to directly access the desired server by the RFID tag data, using the mobile terminal and the RFID reader, which is installed in the mobile terminal or attached to the mobile terminal in a dongle configuration.

1. A data processing method comprising:
recognizing tag data at a mobile terminal;
obtaining connection data for access to contents from the recognized tag data; and
accessing contents using the obtained connection data.

2. The data processing method according to claim 1, wherein the connection data are position data for connection to a corresponding system.

3. The data processing method according to claim 1, wherein the connection data are URL-based server position data.

4. The data processing method according to claim 1, wherein the connection data are address data for receiving contents using an object ID or an EPC code in an RFID tag.

5. A data processing method comprising:
recognizing tag data at a mobile terminal;
connecting to a first server according to the recognized tag data to obtain connection data; and
connecting to a second server using the obtained connection data to access corresponding contents.

6. The data processing method according to claim 5, wherein the connection data are position data for connection to a corresponding system.

7. The data processing method according to claim 5, wherein the connection data are URL-based server position data.

8. The data processing method according to claim 5, wherein the connection data are address data for receiving contents using an object ID or an EPC code in an RFID tag.

9. The data processing method according to claim 5, wherein the first server is an object directory server.

10. The data processing method according to claim 5, wherein the first server is an object directory server in which addresses of content servers corresponding to respective object ID are mapped.

11. The data processing method according to claim 5, wherein the connection data server is an object directory server in which addresses of content servers corresponding to respective EPC codes are mapped.

12. The data processing method according to claim 5, wherein the second server is a content server.

13. An RFID data processing system comprising:
a connection data server for content server connection data to a mobile terminal; and
a mobile terminal for connecting to the connection data server according to tag data recognized using an RFID reader to obtain content server connection data, and connecting to a corresponding content server using the obtained content server connection data.

14. The RFID data processing system according to claim 13, wherein the connection data server is an object directory server in which addresses of content servers corresponding to respective object ID are mapped.

15. The RFID data processing system according to claim 13, wherein the connection data server is an object directory server in which addresses of content servers corresponding to respective EPC codes are mapped.

16. The RFID data processing system according to claim 13, wherein the connection data is an address value of the content server.

17. The RFID data processing system according to claim 13, wherein the connection to the content server is performed based on a WAP.

18. A mobile terminal comprising:
an RFID reader for recognizing RFID tag data; and
an object directory server (ODS) module for accessing an ODS server according to the recognized RFID tag data to obtain data for connection to a content server.
